(19) United States
(12) Patent Application Publication
(10) Pub. No.: US 2016/0049716 A1
(43) Pub. Date: Feb. 18, 2016

(54) COUPLING ARRANGEMENT BETWEEN CAVITY FILTER RESONATORS

(71) Applicant: INTEL CORPORATION, Santa Clara, CA (US)

(72) Inventors: Jukka Puoskari, Tupos (FI); Petri Päri, Kempele (FI)

(21) Appl. No.: 14/778,760

(22) PCT Filed: Jun. 25, 2014
(86) PCT No.: PCT/IB2014/001987

§ 371 Date: Sep. 21, 2015

Related U.S. Application Data
(60) Provisional application No. 61/839,093, filed on Jun. 25, 2013.

(51) Int. Cl. H01P 7/06; H01P 1/20

(52) U.S. Cl. CPC H01P 7/06; H01P 1/20

(57) ABSTRACT

One or more adjustable resonators (208, 209) of a compensation circuit arranged so that adjusting the resonators nevertheless results in output of the circuit remaining substantially constant. This has been accomplished by placing the resonator cavities in the partition wall. A coupling aperture (205) provides inductive coupling between the resonator cavities and a capacitive part (206) passes through the intermediate wall. The capacitive part is conductive and electrically isolated from the partition wall, which produces a capacitive part of the resonator cavities between the capacitive couplings. The capacitive part and the coupling aperture are dimensioned such that adjusting the resonators made up of the device and the aperture and capacitive couplings track changes so as to substantially cancel each other out, and that the coupling remains substantially constant.

### BACKGROUND OF THE INVENTION

1. Field of the Invention

The invention relates to the arrangement of adjustable resonators between the concoction of a resonator with a bottom, walls and a lid consisting of the transmission path destination based casing, which is divided into conductive intermediate walls resonator cavities and in resonator cavities the inner conductor which is in electrical connection with the shell and the resonator cavity the transmission path of successive cavities in the separating intermediate walls is at least one connection opening, which is arranged to form the inductive coupling between the resonator cavities. In addition, the invention relates to a method for the adjustable coupling between the resonators organization.

2. Description of the Prior Art

Common radio frequency resonators are different irons cavity and coaxial resonators, since they can be built with low loss and relatively high powers are sustained by filters containing them. The basic structure of the resonator includes an inner conductor, which includes side walls, an outer conductor, a bottom and a lid. The bottom or base and lid are in a galvanic connection with the outer conductor, and all three together form a closed resonant resonator case. Typically, the lower end of the inner conductor is galvanically linked to the bottom and the upper end to the air. When forming a transmission line resonator it is short-circuited at its lower end and open at its upper end.

Cavity resonators are commonly used for making the filters in telecommunications networks, in particular, when the transmitted signal power is relatively high. This is because losses are due to smaller resonator filters, which is only a very small attenuation related to the efficiency of the signal. In addition, the response characteristics are well controllable and adjustable to most stringent specifications. Most of the filters and the filter pass band width of the space are intended to be fixed. For some of the filters, the filter passband width is supposed to be constant, but on the pass-band it is selected to be contained in a total area. This filter is required in addition to the basic tuning range for the pass-band transmission.

A bandpass filter frequency response arranged to conform to the pass band has to be correctly positioned and the drive axle must be of the correct width. In the resonator filter, this requires that the resonant frequency of each resonator is in the eigenfrequency, i.e., the right, and in addition to the couplings between the resonators, have the correct intensity. The cavity resonator series of a filter are formed from mechanical dimensions so that these conditions are met as well. In practice, the manufacturing process is not accurate enough, so that the filter is tuned before use.

Sequentially coupling between the resonators is achieved by the resonator cavity's gap between partition walls, which forms the inductive coupling between the resonators. When the resonators of a device, such as a filter, have the fundamental frequency changed downwardly, the inductive coupling is reduced linearly with frequency. Switching change results in frequency bands, which in turn change the properties of the device. FIG. 1 shows how a change affects the coupled resonant frequency of the coupling. The amount of coupling is described in the pass band width, and its unit is MHz.

When tuning resonators, vibration occurs in the connections of the resonators. The latter adjustment affects the filter bandwidth. Both of these adjustments can be carried out in several ways. The traditional method is to provide a structure with metallic tuning screws so that they extend into the resonator cavities and/or to the coupling between the resonator holes. For example, is rotated further into the coupling adjustment screw coupling to the top of the filter into the opening of the increasing coupling between the resonators, which has a bandwidth broadening effect. Such an excitation is time-consuming and therefore relatively expensive. What is needed is an improved coupling arrangement between cavity filter resonators.

### SUMMARY OF THE INVENTION

The present invention is an arrangement for compensating the coupling between resonators in such a way that the resonators made up of adjusting the coupling device remains substantially constant. This has been accomplished by placing the hole in the partition wall of the resonator cavities, producing resonator cavities between the inductive coupling, in addition to a capacitive piece, which is galvanically separated from the partition wall, and which produces the capacitive piece between the capacitive coupling. The capacitive piece is a coupling aperture and is dimensioned such that adjusting the resonators made up of the device hole and a capacitive couplings track changes substantially cancel each other out, and that the coupling remains substantially constant.

According to one embodiment of the arrangement, the adjustable resonators provide for coupling between resonator bottom, walls and a lid, which is the transmission path destination operating envelope. It is divided into conductive intermediate walls resonator cavities. In the resonator cavities, the inner conductor is in electrical connection with the shell and the resonator cavity with the transmission path of successive cavities in the separating walls. At least a coupling opening is provided which is arranged to form the inductive coupling between the resonators. According to a preferred embodiment, the arrangement having at least one capacitive part, which is arranged to form a capacitive coupling between the resonators, in the capacitive piece, which has a first end and a second end, the ends of which are successive and in resonator cavities capacitive part a conductive material, and it is galvanically separated from the partition wall.

In an arrangement according to the invention in one embodiment, the capacitive part is an elongated plate-like piece. In an arrangement according to the invention in another embodiment, the first and second capacitive part ends are shaped to enhance coupling. According to another arrangement of the invention, in a certain third performance mode the surfaces of the ends of the capacitive piece are larger than the surface of a cross-section of the capacitive piece. In an arrangement according to the invention in a third embodiment, the ends of the capacitive part surface are greater than the capacitive part cross-sectional area. In an arrangement according to the invention in a fifth embodiment, capacitive track or tracks that are formed by coupling the capacitive magnitude, are less than the absolute value of the coupling hole formed inductively. In an arrangement according to the invention in a sixth embodiment, the capacitive track or tracks are formed by coupling the capacitive absolute value at a magnitude of 40-60% by making a connection hole by inductive coupling. In an arrangement according to the invention in a seventh embodiment, the coupling opening or openings and the coupling capacitive part capacitive pieces or the intermediate wall are arranged so as to change the frequency of the resonator by inductive coupling and the capacitive coupling changes to substantially cancel each other out. In an arrangement according to the invention in a eighth embodiment the capacitive part or capacitive pieces are attached so as to be fixed in place; i.e., it is stationary.

According to one embodiment of a method of the invention is disclosed for adjustable resonators coupling between a bottom, walls and a lid of the resonator having a transmission path destination operating envelope, which is divided into conductive intermediate walls resonator cavities and in resonator cavities the inner conductor which is in electrical connection with the shell and the resonator cavity the transmission path of successive cavities in the separating walls, at least a coupling opening which is arranged to form the inductive coupling between the resonators. According to a preferred embodiment, at least one of the leading capacitive parts in the capacitive piece has a first end and a second end, the ends of which are successive in resonator cavities. In this case, the first end of the second and the other end of the second in resonator cavities. The capacitive part is made of a conductive material and it is galvanically separated from the partition wall. The method has the steps of coupling the orifice to form the inductive coupling between resonators and the capacitive parts of the resonator cavities to form a capacitive coupling between the resonator. That capacitive coupling is changed and the frequency of the inductive coupling and the capacitive coupling changes substantially cancel each other out, and the bandwidth of the resonator and the coupling will remain substantially constant.

An advantage of the present invention is that it achieves an arrangement in which the coupling between the resonators remains substantially the same while frequency adjusting without moving parts. In addition, the present invention has the advantage that its structure is simple and thus the production cost is reduced and component and subsystem failures decrease. Furthermore, the invention has the advantage that it will facilitate and accelerate adjustment. Further, the invention enables the reproducibility of settings to produce the same results. The invention also has the advantage that the resonance frequency of the set is held in place and does not change with time because the time varying components can be reduced. When the pieces have been set active control is not needed.

### BRIEF DESCRIPTION OF THE DRAWINGS

The invention will now be described in detail. In the description reference is made to the accompanying drawings, in which

FIG. 1 illustrates a dependency capacity and the resonance frequency;

FIG. 2 shows an example of an arrangement according to the present invention;

FIG. 3 shows a second example of an arrangement according to the present invention;

FIG. 4 shows a section A-B of the FIG. 3 example,

FIG. 5 shows a third example of an arrangement according to the present invention as shown in FIG. 4,

FIG. 6 shows an example of the arrangement according to the present invention showing capacity and the dependence of the resonance frequency, and coupling the inductive and a capacitive component;

FIG. 7 shows an example of changes in adjusting the coupling resonators in different frequency bands and the arrangement according to the invention versus the traditional method.

### DETAILED DESCRIPTION OF THE INVENTION

In the following description, the embodiments are exemplary only and the person skilled in the basic idea of the invention will understand that it may be taken in some other way than described in the specification. Although the description may refer to one or more embodiments, it does not mean that it is limited to the described embodiment or feature or that the invention described would be useful only in conjunction with the illustrated embodiment. Two or more individual features of embodiments can be combined and thus provide novel embodiments of the invention.

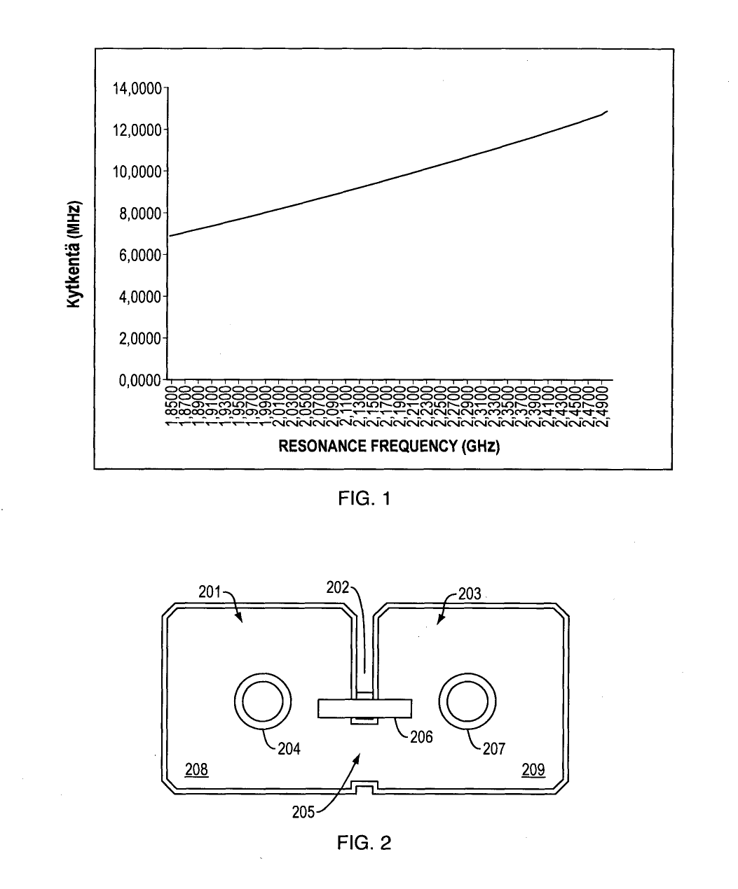

FIG. 1 shows the prior art resonance provided by existing cavity resonators.

In FIG. 2, there are two resonators: a first resonator 208 and a second resonator 209. The first resonator 208 includes a first resonator cavity 201, which is surrounded by a bottom, a wall and a cover. These form a resonator shell. The first resonator cavity 201 includes a first inner conductor 204, which is in electrical connection with the shell. In the example, the inner conductor is attached to the bottom, but other solutions are possible. A second resonator cavity 203 includes a second inner conductor 207. A partition wall is between the resonator cavities. Leading partition 205 includes a coupling hole. The coupling hole forms an inductive coupling between the resonators.

The first resonator cavity 201 and the second resonator cavity 203 include a capacitive part 206. The capacitive part 206 has an elongated part which penetrates septum 202. The capacitive part 206 has a shape and a location to the partition wall that are substantially symmetrical in relation and to the inner conductors 204 and 207. The capacitive part 206 is made of a conductive material. The capacitive part is arranged in such a way that it can be placed and is galvanically separated from the partition wall and at the same time frame. In this example, the capacitive part 206 is placed so that it includes a first region and a second region between the inner conductors. In one example of the invention, the capacitive part 206 is plate-shaped, but other shapes are possible, for example, rods, tubes, or a combination of several forms.

The capacitive part 206 forms a capacitive coupling between the resonators. Thus, for example, in the case of the coupling hole being formed by inductive and capacitive coupling, these connections are opposite to each other. When the frequencies of the resonators are changed, inductive and capacitive coupling also change. For example, when the frequency of the resonators are moved downwardly, the two couplings are reduced. Due to the characteristics of the capacitive coupling, that coupling is reduced more quickly than the inductive coupling. Both connection changes cancel each other out, and the overall connection will remain roughly the same in spite of the frequency adjustment. Studies have shown that the best results are obtained when the coupling hole and the capacitive part 206 are selected so that the amount of capacitive coupling is smaller than the absolute value of the inductive coupling. Absolute value of the amount of capacitive coupling is from 40 to 60% when making the coupling hole by inductive coupling. The capacitive part is shown in FIG. 2 as a single piece but it may be made in two or more pieces. This may be the case, for example, to control resonances. A unitary capacitive part may produce resonances that can grow too much. In order to reduce that, the capacitive part may be made in capacitive pieces. Adjusting the resonance frequency of the resonator has a resonator control arrangement.

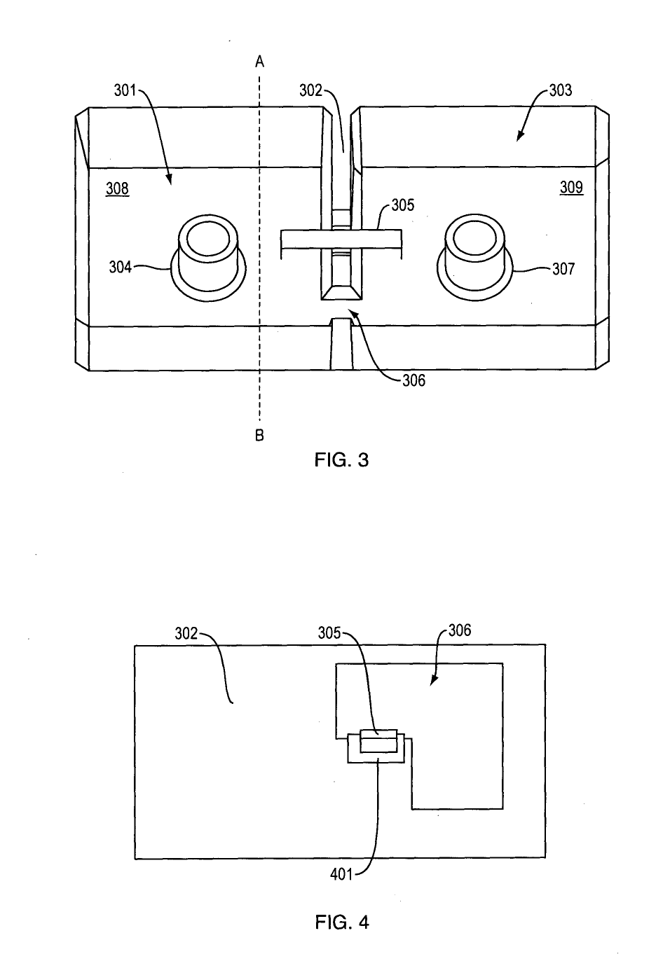

FIG. 3 shows a second example of an arrangement according to the present invention. It consists of two resonators: a first resonator 308 and a second resonator 309. The first resonator has a first resonator cavity 301, and a first inner conductor 304. The second resonator 309 includes a second resonator cavity 303 and a second internal conductor 307. A partition wall 302 spaces the resonator cavities and includes a coupling neck or aperture 306. The walls of the coupling aperture 306 are shaped to be compatible with capacitive part 305. Capacitive part 305 has a first and a second end, with the first end in the first resonator cavity 301 and the second end in the second resonator cavity 303. The first and second ends are shaped to enhance coupling. In this formulation, the surface areas of the ends of the capacitive part 305 are larger than the cross-sectional area of the capacitive part 305. This can been done, for example, by bending a plate-like version of the capacitive part 305 or by connecting the ends of an additional piece. A mourning hole at the edge switch is designed to galvanically isolate the capacitive part 305 from the partition wall 302. In this example, insulation may be a plastic, and bolts may be used to join pieces together. There are also other ways to attach alternative components of the capacitive part 305. For example, it may be arranged to run through the aperture 306 and the coupling attached to the shell, for example, with plastic plugs. This may be useful if the coupling aperture 306 is not of a desired format or dimensions.

FIG. 4 is an example of a portion of the cavity resonator of FIG. 3 taken at cross-section line A-B in the direction parallel to the direction of the partition wall 302. The drawing shows in more detail the coupling aperture 306 and capacitive part 305 as placed with respect to the partition wall 302. The coupling aperture 306 has a projection, which is positioned so that it is separated by the partition wall 302 between the inner conductors of the resonators. Capacitive pieces of capacitive part 305 are separated by a partition wall. Insulating part 401, which separates the partition wall 302 from the capacitive part 306. The size of the insulating part 401 and its material are selected so that the capacitive part 305 is galvanically separated from the partition wall 302.

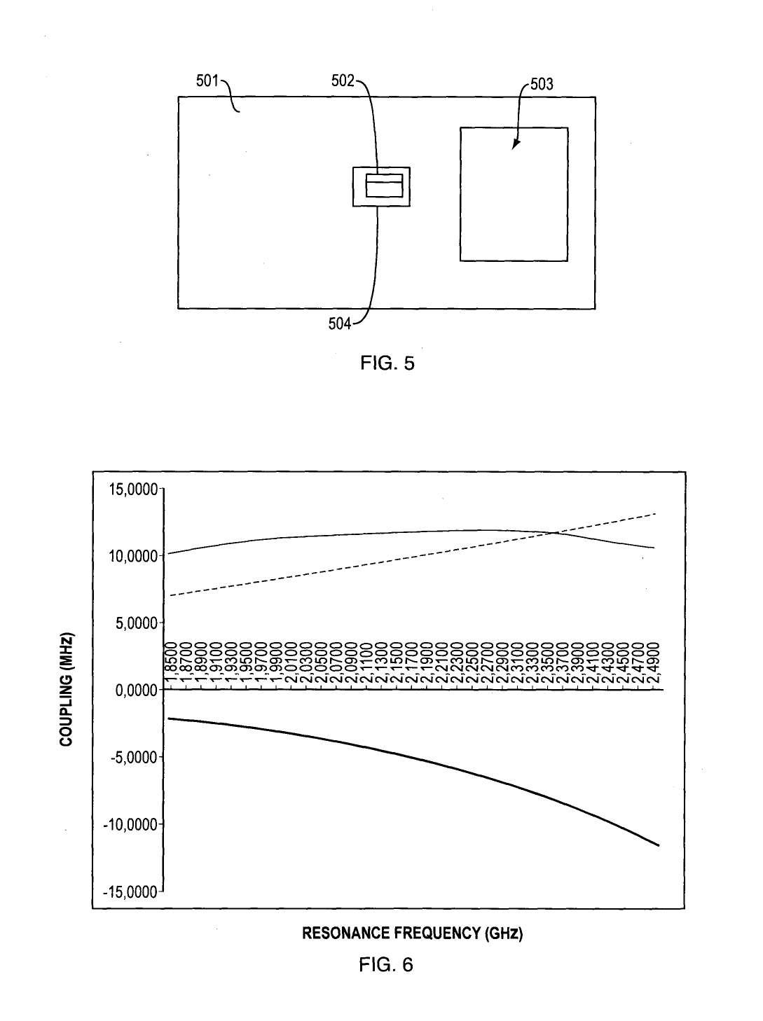

FIG. 5 shows a third example of an arrangement according to the present invention. The picture is similar to that shown in FIG. 4. Partition wall 501 includes a coupling aperture 503. Capacitive piece 502 is arranged to pass through the partition wall 501 and the partition wall 501 separates the capacitive piece 502 from insulation section 504. Although the example of the invention shown in FIG. 5 illustrates a single coupling aperture 503, multiple coupling apertures may be provided in the partition wall 501.

A resonator arrangement according to the present invention does not necessarily have to be rectangular as is shown in the examples, but it may be, for example cylindrical or another shape. A resonator in a regular geometric shape allows for ease of the calculation of properties and evaluation as wed as ease of industrial manufacturing.

FIG. 6 is an example of relations between the coupling and the resonance frequency of an example of the device of the present invention in which the resonators are adjustable. The x-axis depicts resonant frequency and the Y-axis depicts coupling magnitude. The invention is shown to perform differently to the resonator of FIG. 1. Inductive coupling (dashed line), the capacitive coupling (solid line) and the overall coupling (dotted line) are represented for the situation in which the unit arrangement is according to the invention. The amount of capacitive coupling is shown as a negative. It should be noted that the total does not directly represent the inductive and capacitive coupling amount, but illustrates the situation in which the two frequency conversion connection changes compensate each other so that the total wiring remains substantially constant.

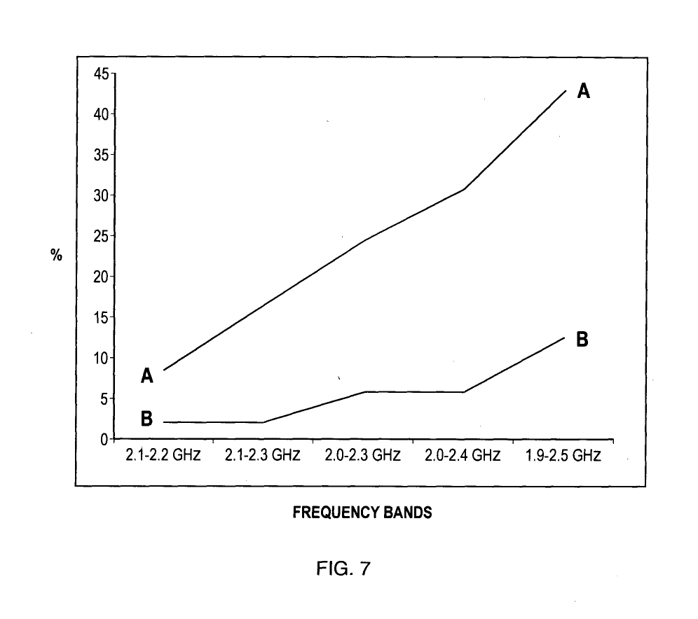

FIG. 7 shows by way of example linkage of changes in different frequency bands in a device of the invention with adjustable resonators. For each frequency band, the resonance frequency of the resonators is changed. Changes in resonant frequency caused by the connection changing are shown in percentages. These changes should be adapted to the curve. In the Figure, the curves are shown as curve A and curve B. Curve A illustrates the traditional apparatus. Curve B is obtained by using a device with the arrangement according to the present invention. There are live frequency bands, 2.1˜2.2 GHz, 2.1˜2.3 GHz, 2.0˜2.3 GHz, 2.0˜2.4 GHz and 1.9˜2.5 GHz. Resonant frequency has been changed max to min. Connection changes are shown in percentages. For example, in band 2.1˜2.3 GHz, a change using the traditional apparatus is 15%, whereas the arrangement of the present invention results in a change of only 2%. In the band of 1.9˜2.5 GHz, a change using the traditional device is 43%, but the arrangement according to the present invention produces a change of only 12%.

An arrangement in accordance with the present invention enables the use of adjustable resonators allows for easy adjustment of the device, since the switching device according to the example is not affected by resonance frequency changes with respect to the changes that occur tor existing cavity resonator filters.

Having described the invention in accordance with certain preferred embodiments. The present invention is not limited to the solutions just described, bur the inventive idea can be applied in numerous ways within the limits of die appended claims.

What is claimed is:

1. An adjustable cavity resonator having a bottom, walls and a lid, and a transmission path destination based casing, which is divided into a plurality of cavities by one or more conductive intermediate walls, each resonator cavity including an inner conductor, which is in electrical connection with the casing and providing coarse resonator filter of the transmission path between successive cavities through the one or more conductive intermediate walls, at least one coupling aperture, which is arranged to form inductive coupling of successive resonators, characterized in that the resonator has at least one capacitive part, which is arranged to form a capacitive coupling of resonators, wherein the capacitive part bus a first end and a second end, the ends of the capacitive part are formed of a conductive material and are galvanically separated by a partition wall.

2. The resonator according to claim 1, wherein the capacitive part is characterised in that the capacitive part is an elongated plate-like piece.

3. The resonator according to claim 1, wherein the first and second ends of the capacitive part are shaped to enhance coupling.

4. The resonator according to claim 3, wherein the surface area of the ends of the capacitive part are greater than the cross-sectional area of the capacitive pan.

5. The resonator according to claim 1, wherein the first and second ends of the capacitive part are substantially in successive resonator cavities of the inner conductor in the area there between.

6. The resonator according to claim 1, wherein the capacitive part or tracks formed by coupling the capacitive magnitude is less than the absolute value of the coupling aperture formed by an inductive coupling.

7. The resonator according to claim 6, wherein the capacitive part or the tracks formed by coupling the capacitive absolute value of the magnitude of 40-60% of the coupling aperture make a inductive coupling.

8. The resonator according to claim 1, wherein the coupling aperture and the capacitive part are arranged in the partition wad so as to change the resonator frequency of the coupling wherein the inductive and capacitive coupling changes substantially cancel each other out.

9. The resonator according to claim 1, wherein the capacitive part is attached so that it is fixed in position.
